(19) United States
(12) Patent Application Publication
(10) Pub. No.: US 2009/0140998 A1
(43) Pub. Date: Jun. 4, 2009

(54) MOBILE TERMINAL HAVING TOUCH SCREEN AND METHOD FOR INPUTTING CHARACTERS THROUGH THE SAME

(75) Inventors: Jong-woo JUNG, Seoul (KR); Young-wan SEO, Yongin-si (KR); Il-ku Chang, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/325,044

(22) Filed: Nov. 28, 2008

(30) Foreign Application Priority Data
Dec. 3, 2007 (KR) 10-2007-0124269

(51) Int. Cl. G06F 3/041

(52) U.S. Cl. 345/173

(57) ABSTRACT

A mobile terminal having a touch screen and a method of inputting characters through the touch screen of the mobile terminal. When a user inputs characters though a touch screen of a mobile terminal, he or she can copy already written characters, character strings or images, or paste the copied characters, character stings or images, through a drag operation. Therefore, a user is allowed to copy or paste characters through a drag operation, when inputting the characters through a touch screen of a mobile terminal.

### CROSS-REFERENCE TO RELATED APPLICATIONS

This application claims the benefit under 35 U.S.C. § 119(a) of Korean Patent Application No. 10-2007-0124269, filed on Dec. 3, 2007, the disclosure of which is incorporated herein in its entirety by reference.

### BACKGROUND

1. Field

One or more embodiments of the present invention relate to a mobile terminal having a touch screen, and more particularly, to a mobile terminal having a touch screen and a method of inputting characters through the touch screen of the mobile terminal.

2. Description of the Related Art

There have been developed various kinds of mobile terminals which can perform various functions, such as voice communications, video communications, message transmission/reception, camera function and digital multimedia broadcasting (DMB) or digital video broadcasting (DVB). The message transmission/reception function among the functions allows users to transfer/receive information or messages to/from the other party anywhere and any time. Also, since such message communications are being serviced at a price lower than voice communications, the number of users using message communications is increasing more and more.

Also, recently, due to diversification in the designs of mobile terminals, the adoption of touch screens in mobile terminals is increasing. A touch screen has an advantage of integrating the display and input parts of a mobile terminal into a single unit. Also, a mobile terminal having a touch screen can intuitively detect a signal input by a user through the touch screen.

### SUMMARY

One or more embodiments of the present invention include a mobile terminal having a touch screen and a method of inputting characters to the mobile terminal by a drag operation on the touch screen of the mobile terminal.

Accordingly, in an aspect, there is provided method of inputting a character in a mobile terminal having a touch screen, including displaying a character input window in a character writing mode, determining whether a drag operation is detected on the character input window, determining whether a character exists on an area dragged by the drag operation based on the determination of whether the drag operation is detected, determining whether any touch is detected on the dragged area based on the determination of whether a character exists on the dragged area, and storing the character in a clip board upon a touch being detected on the dragged area.

The character input method further includes displaying characters stored in the clip board on the dragged area upon the determination of whether the character exists indicates that no character exists on the dragged area.

The displaying of the characters stored in the clip board includes calculating a number of characters which are to be displayed on the dragged area, and displaying characters stored in the clip board on the dragged area according to the number of characters.

The character input method further includes determining whether a key input is detected, determining whether the key input is a key input for selecting the clip board, displaying characters stored in the clip board on the dragged area based on a result of the determining of whether the key input is the key input for the selecting of the clip board, and displaying a character selected from among the displayed characters based on a determination of whether a key is input for selecting at least one character among the displayed characters.

The character input method further includes displaying a character corresponding to the key being input upon the key input being a key input for inputting a character.

The characters stored in the clip board include at least one of a character, digit, character string, digit string, and image.

According to an aspect, there is provided a mobile terminal including displaying the image, recognizing an area dragged by a drag operation based on a determination of whether the drag operation on the displayed image is detected, determining whether a touch is made on the dragged area, recognizing the image corresponding to the dragged area based upon a determination of whether a touch on the dragged area is detected, and storing the image in a clip board.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram of a mobile terminal according to an embodiment;

FIG. 2 is a flowchart of a method of inputting characters according to an embodiment;

FIG. 3 is a flowchart of a method of inputting characters by a drag operation on a touch screen, according to an embodiment;

FIGS. 4A through 4D are views for explaining a process of storing characters displayed on a touch screen in a mobile terminal by a drag operation, according to an embodiment;

FIGS. 5A through 5C are views for explaining a process of displaying characters on a touch screen by a drag operation, according to an embodiment;

FIG. 6 is a flowchart of a method of inputting characters to a mobile terminal through key input, according to an embodiment; and

FIG. 7 is a flowchart of a method of storing an image in a mobile terminal by a drag operation, according to an embodiment.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

A “character” is a fundamental unit constructing character data that is to be input to a mobile terminal, wherein the term “character” includes a word or string consisting of several characters and the term “character data” includes short messages, multimedia messages, E-mails, instant messages, file names used to store files, etc., documents, etc.

Herein, a “clip board” is included in a storage, and temporarily stores characters, character strings, images, etc. copied by a drag operation. Also, a user can check the characters, strings, or images stored temporarily in the clip board.

Hereinafter, embodiments will be described in detail with reference to the appended drawings.

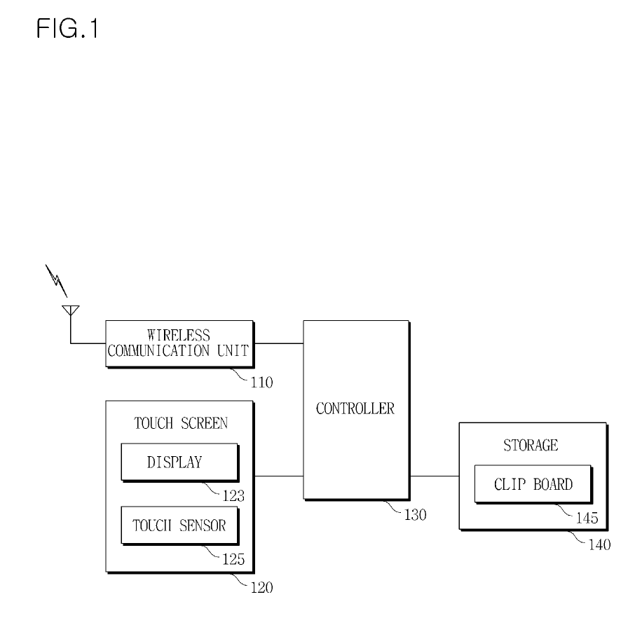

FIG. 1 is a block diagram of a mobile terminal according to an embodiment.

Referring to FIG. 1, the mobile terminal includes a wireless communication unit 110, a touch screen 120, a controller 130, and a storage 140.

The wireless communication unit 110 performs communications between the mobile terminal and a base station. The wireless communication unit 110 includes a duplexer for separating transmission/reception functions, a transmitter for ramping up the frequencies of signals to be transmitted, and a receiver for ramping down the frequencies of received signals.

The touch screen 120 includes a display 123 and a touch sensor 125. The display 123 displays various information associated with the status and operation of the mobile terminal. Also, the display 123 displays key areas, and allows a user to input functional keys, character keys, or digit keys therethrough, without having to input them through a separate input unit. The touch sensor 125 is installed in the display 123, detects a touch on the display 123, and detects the coordinate of an area where the touch is made. The touch sensor 125 transmits the coordinate of the area to the controller 130, and the controller 130 controls the touch sensor 125 to perform a function corresponding to the area where the touch has made. In a character writing mode, if the touch sensor 125 detects a drag operation, the touch sensor 125 detects the start and end points of an area dragged by the drag operation, and transmits coordinate values corresponding to the start and end points of the dragged area to the controller 130.

The controller 130 controls the entire status and operation of the mobile terminal. Particularly, in the character writing mode, the controller 130 may copy characters by a drag operation detected on the touch screen 120, and paste the copied characters on an area dragged by a drag operation. In other words, when a drag operation on the touch screen 120 is detected, the controller 130 detects the presence of any character on an area dragged by the drag operation, and copies and stores characters existing on the area in a clip board 145 of the storage 140 when detecting the presence of any character. When no character exists on the dragged area, the controller 130 accesses the clip board 145 of the storage 140 and displays the latestly stored character on the dragged area. When displaying the characters on the dragged area, the controller 130 calculates the number of characters that can be displayed on the dragged area by detecting the start and end points of the dragged area, and displays a part of characters stored in the clip board 145 on the dragged area by the number of characters.

Also, when an image or characters exist on the dragged area, the controller 130 recognizes the dragged area, and copies the image or characters displayed on the dragged area and then stores them in the clip board 145.

The storage 140 stores various programs for controlling the operations of the mobile terminal and various data generated when the mobile terminal operates. Particularly, the storage 140 includes the clip board 145, and stores characters, digits, character strings, digit strings or images copied by a drag operation. Characters, digits, character strings, digit strings or images are stored temporarily in the clip board 145, but can be stored semipermanently according to a user's settings. The number of characters, digits, character strings, digit strings or images that can be stored in the clip board 145 may be limited. For example, the number of characters, character strings or images that can be stored in the clip board 145 may be set to a maximum of 10. When more than 10 characters, character strings or images have to be stored in the clip board 145, characters, digits, character strings, digit strings or images stored in advance in the clip board 145 can be deleted in the order where they have been stored. The number of characters, digits, character strings or images that can be stored in the clip board 145 can be set to an appropriate value by a user's settings or by the manufacturer of the corresponding mobile terminal. In the following description, characters, character strings, digits, digit strings or images will be called “characters”.

In the mobile terminal having the above-described construction, in the character writing mode, the controller 130 determines whether a drag operation is detected through the touch screen 120, and detects the presence of a character on an area dragged by the drag operation. When a character exists on the dragged area, the controller 130 stores the character existing on the dragged area in the clip board 145 of the storage 140. When no character exists on the dragged area, the controller 130 accesses the clip board 145 of the storage 140, calculates the number of characters that can be displayed on the dragged area, and then displays a part of characters stored in the clip board 145 on the dragged area by the number of characters.

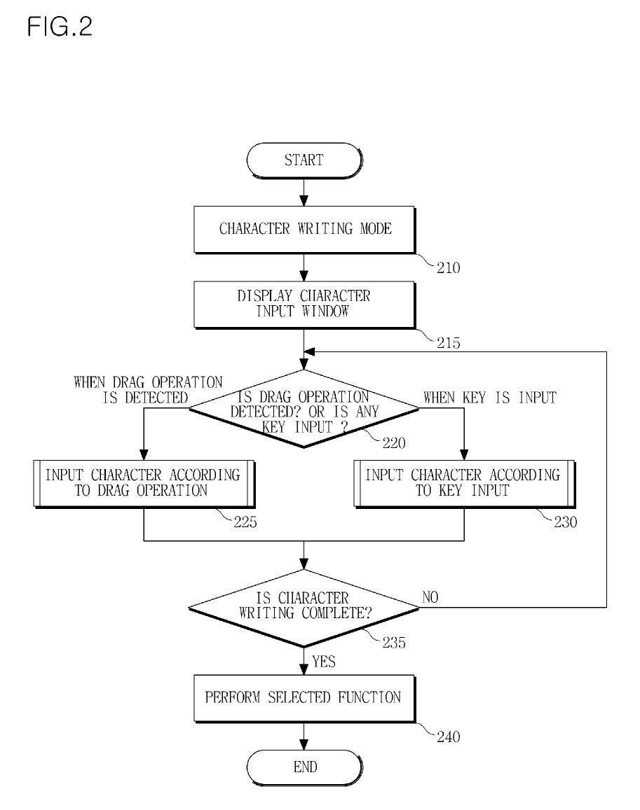

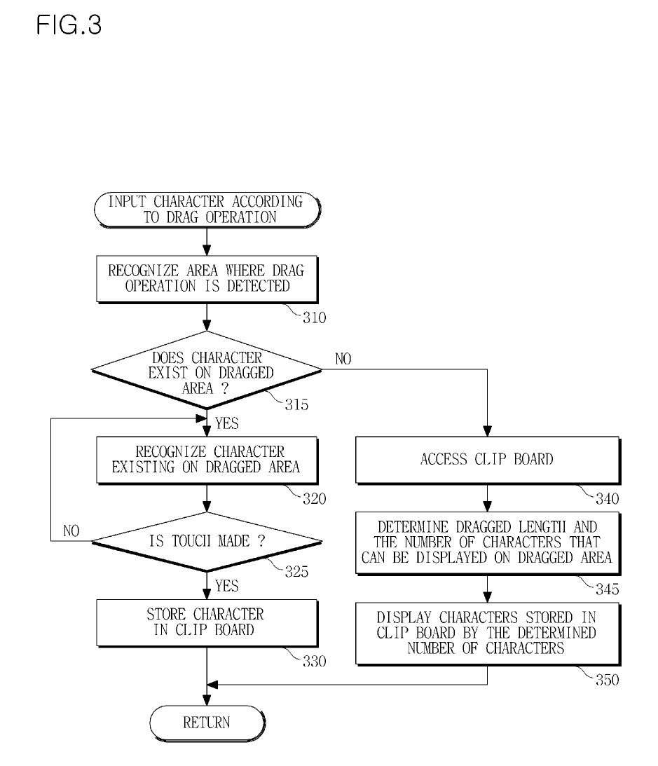

FIG. 2 is a flowchart of a method of inputting characters according to an embodiment. The character input method illustrated in FIG. 2 will be described with reference to FIGS. 3 through 6 below.

Referring to FIG. 2, when a user selects a character writing mode to write a message or to draw up a document through a key area displayed on the touch screen 120 (see FIG. 1), the controller 130 recognizes the user's selection and enters the character writing mode, in operation 210. Then, the controller 130 displays a character input window, in operation 215.

Next, the controller 130 determines whether a drag operation is detected or any key is input though the touch screen 120, in operation 220. If a drag operation is detected through the touch screen 120, the controller 130 recognizes an area dragged by the drag operation, and can copy characters existing on the dragged area or paste already copied characters on the dragged area. Here, the characters may be digits, character strings, or images.

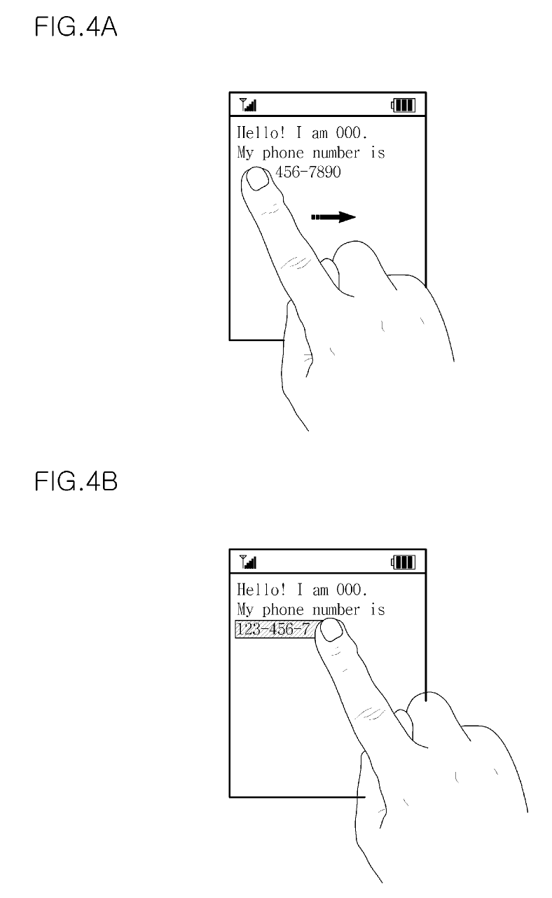

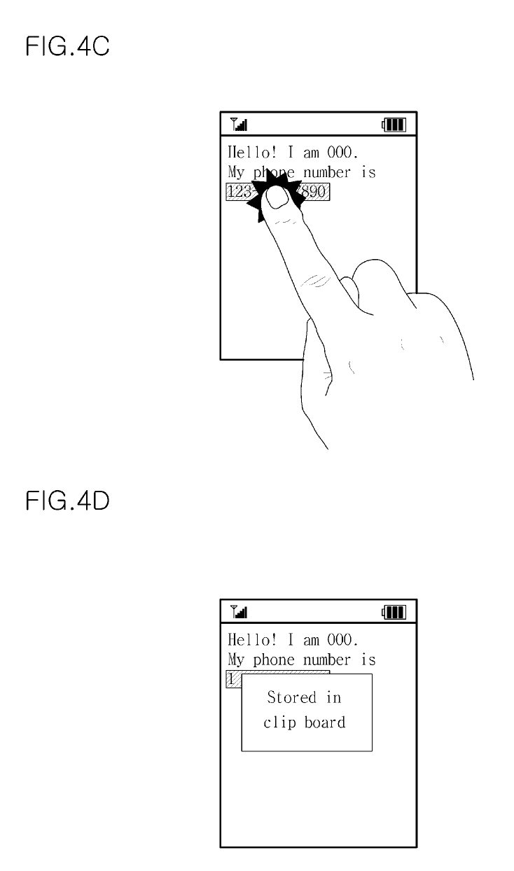

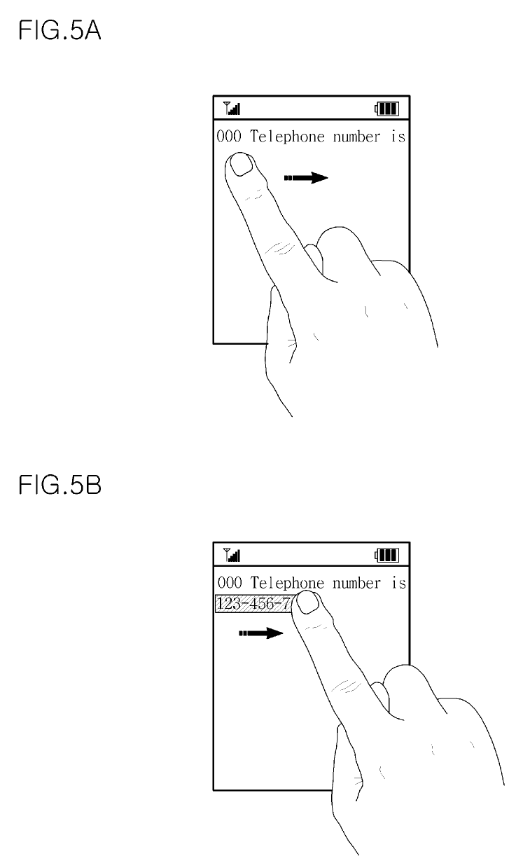

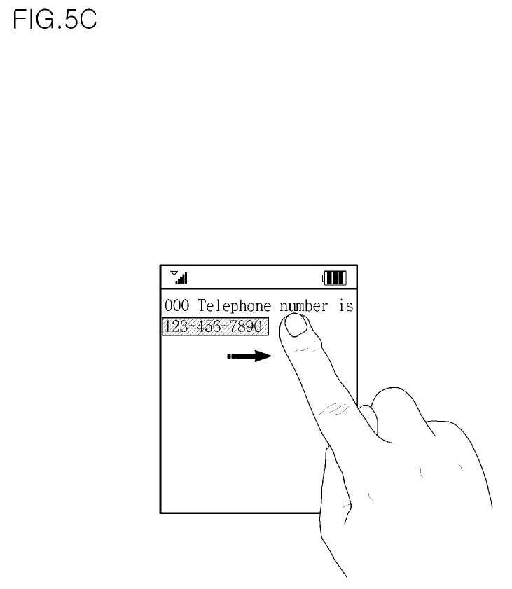

When the drag operation is detected through the touch screen 120, the controller 130 inputs characters according to the drag operation, in operation 225. Operation 225 will be described in detail with reference to FIGS. 3 through 5C below. FIG. 3 is a flowchart of a method of inputting characters by a drag operation, according to an embodiment. FIGS. 4A through 4D are views for explaining a process of storing characters displayed on a touch screen in a mobile terminal by a drag operation, according to an embodiment. FIGS. 5A through 5C are views for explaining a process of displaying characters on a touch screen by a drag operation, according to an embodiment.

Referring to FIG. 3, if a drag operation is detected through the touch screen 120, the controller 130 recognizes an area dragged by the drag operation, in operation 310. In more detail, the controller 130 recognizes an area dragged by the drag operation by detecting the start and end points of the dragged area. Then, the controller 130 detects the presence of any character on the dragged area, in operation 315.

If at least one character exists on the dragged area, the controller 130 recognizes the character existing on the area, in operation 320. In other words, if a user drags an area where a telephone number 123-456-7890 is displayed to copy the telephone number 123-456-7890, as illustrated in FIGS. 4A and 4B, the controller 130 detects the drag operation and recognizes the telephone number 123-456-7890 displayed on the dragged area. Here, the controller 130 highlights on the dragged area, thereby differentiating the dragged area from the other area.

Then, the controller 130 determines whether a touch is made on the dragged area, in operation 325. In other words, if a user touches the dragged area, as illustrated in FIG. 4C, the controller 130 detects the user's touch, and stores the telephone number 123-456-7890 corresponding to the dragged area in the clip board 145, in operation 330. At this time, the controller 130 can display a message indicating that the telephone number 123-456-7890 have been stored in the clip board 145, as illustrated in FIG. 4D.

If no touch is detected on the dragged area, the controller 130 can determine whether a drag operation is detected on the remaining area other than the dragged area. Accordingly, a different area on which characters have been displayed can be selected, and the controller 130 can store characters or character strings displayed on the different area in the clip board 145. In other words, the controller 130 can copy a plurality of characters or character strings through a drag operation, and store them temporarily in the clip board 145. After the characters are copied and stored temporarily in the clip board 145 through the drag operation, the controller 130 determines whether a character writing completion is selected, in operation 235 (see FIG. 2).

If it is determined in operation 315 that no character exists on the dragged area, the controller 130 accesses the clip board 145, in operation 340. Then, the controller 130 recognizes the length of the dragged area and the number of characters that can be displayed on the length of the dragged area, in operation 345, and displays a part of characters stored in the clip board 145 on the dragged area by the number of characters that can be displayed within the length of the dragged area, in operation 350.

In other words, as illustrated in FIG. 5A, if a user starts a drag operation, the controller 130 accesses the clip board 145, measures the length of an area dragged by the drag operation by detecting the start and end points of the dragged area, and calculates the number of characters that can be displayed within the dragged area. For example, the controller 130 can calculate the number of characters that can be displayed within the length of the dragged area, by dividing the length of the dragged area by the width of a character to be displayed on the touch screen 120. Then, as illustrated in FIGS. 5B and 5C, the controller 130 displays a part of characters stored in the clip board 145 by the number of characters that can be displayed within the dragged area. Then, returning to FIG. 2, in operation 235, the controller 130 determines whether a character writing completion is selected.

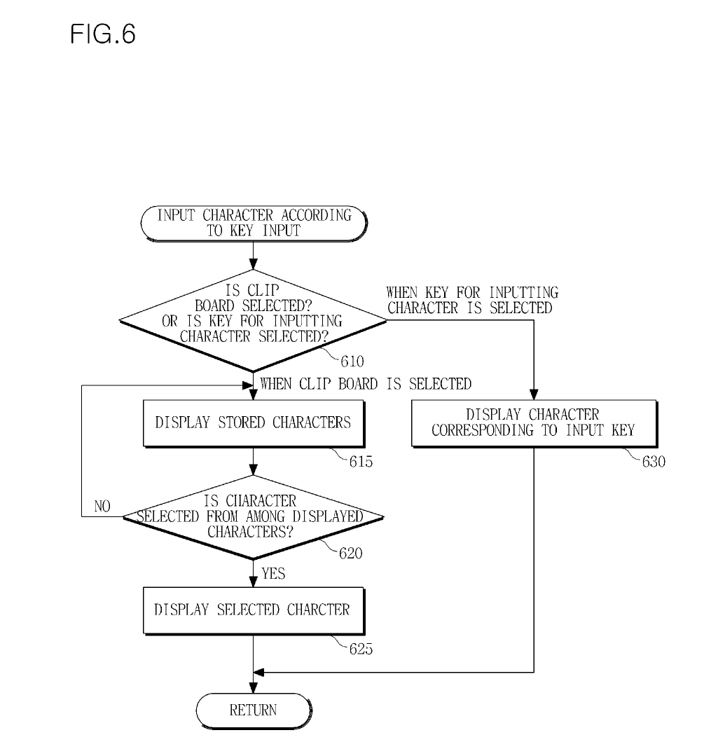

Meanwhile, if it is determined in operation 220 that a key is input, the controller 130 inputs a character corresponding to the input key, in operation 230. Operation 230 will be described in detail with reference to FIG. 6 below. FIG. 6 is a flowchart of a method of inputting characters to the mobile terminal through key input, according to an embodiment.

Referring to FIG. 6, if a touch is detected on a key area displayed on the touch screen 120 or if a key is input through a key input unit, in operation 610, the controller 130 determines whether the key input is a key input for selecting the clip board 145 or a key input for inputting a character.

If the key input is a key input for selecting the clip board 145, the controller 130 displays characters stored in the clip board 145, in operation 615. In other words, if the user selects a functional key for accessing the clip board 145, the controller 130 recognizes the user's selection and displays characters stored in the clip board 145.

Then, in operation 620, the controller 130 determines whether at least one specific character of the displayed characters is selected. If the user selects at least one of characters to be pasted among the displayed characters by touching it or by using a direction key, etc., the controller 130 recognizes the user's selection and displays the selected character, in operation 625. Again returning to FIG. 2, in operation 235, the controller 130 determines whether a character writing completion is selected.

Meanwhile, if the key input is a key input for inputting a character, the controller 130 displays a character corresponding to the input key, in operation 630. In other words, if the user touches a key for inputting a character on a key area or if the user inputs a character key through a key input unit when the mobile terminal includes the key input unit, the controller 130 recognizes a character corresponding to the input key and displays the recognized character. Then, returning to FIG. 2, the controller 130 determines whether a character writing completion is selected, in operation 235.

If it is determined in operation 235 that a character writing completion is selected, the controller 130 performs a function selected by the user, in operation 240. For example, if the character writing mode is a message writing mode, when a character writing completion is selected, the controller 130 display a telephone number input window for allowing a user to input the telephone number of the other party to which a message will be transmitted. Then, if the user inputs the other party's telephone number, the controller 130 recognizes the telephone number, and controls the mobile communication unit 110 to transmit the message to the other party's mobile phone corresponding to the telephone number. If the character writing mode is a mode for drawing up a document, the controller 130 stores the drawn-up document in the storage 140 when the character writing completion is selected.

Hereinafter, a method of storing characters or images selected by a drag operation when the characters or images are recognized will be described. Here, the images may be photographs or pictures stored in the mobile terminal. In the following description, an example of storing images will be described, but characters or character strings forming a message, telephone numbers stored in a telephone directory, etc. can be stored by a drag operation.

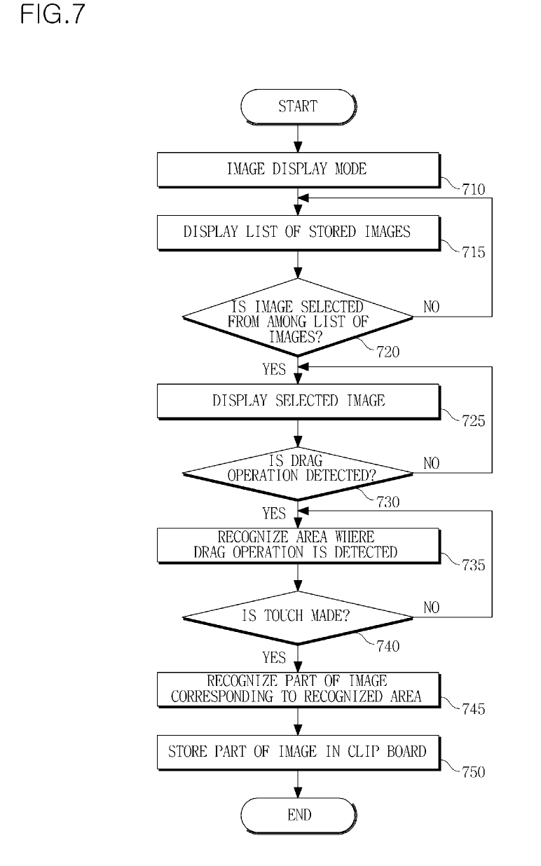

FIG. 7 is a flowchart of a method of storing an image in a mobile terminal by a drag operation, according to an embodiment.

Referring to FIG. 7, if an image display mode for displaying images stored in the mobile terminal is selected through the touch screen 120 (see FIG. 1), the controller 130 (see FIG. 1) enters an image display mode, in operation 710. Then, the controller 130 displays a list of the stored images, in operation 715. Here, the images can be displayed in the form of a list or in the form of thumbnails.

Then, the controller 130 determines whether any image is selected from among the list of images, in operation 720. In other words, if a user selects an image from the list of images through the touch screen 120 or through a key on an input unit, the controller 130 recognizes the user's selection and displays the selected image, in operation 725.

Then, the controller 130 determines whether any drag operation is detected on the selected image, in operation 730. If the user drags a part of the selected image though the touch screen 120 to select the part of the selected image, the controller 130 recognizes the dragged area, in operation 735. In other words, if a drag operation is detected, the controller 130 recognizes an area dragged by the drag operation by detecting the start and end points of the dragged area.

Then, the controller 130 determines whether a touch is made on the dragged area, in operation 740. If a touch on the dragged area is detected, the controller 130 recognizes the part of the image corresponding to the touched area, in operation 745. Then, the controller 130 stores the part of the image in the clip board 145, in operation 750.

Generally, in order to repeatedly input the same character in a mobile terminal having a touch screen or to transmit a telephone number stored in a telephone directory to the other party, a user should repeatedly input a key corresponding to the character or input the telephone number after memorizing it. However, according to the current embodiment, when a user inputs characters though a touch screen of a mobile terminal, he or she can copy already written characters, character strings or images, or paste the copied characters, character stings or images, through a drag operation. Accordingly, a user can easily input characters, etc., without having to input characters, etc. that are repeatedly used through character keys. Also, when transmitting a third party's telephone number to the other party, a user can input the telephone number through a drag operation without having to memorize the telephone number.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A method of inputting a character in a mobile terminal having a touch screen, comprising:
displaying a character input window in a character writing mode;
determining whether a drag operation is detected on the character input window;
determining whether a character exists on an area dragged by the drag operation based on the determination of whether the drag operation is detected;
determining whether any touch is detected on the dragged area based on the determination of whether a character exists on the dragged area; and
storing the character in a clip board upon a touch being detected on the dragged area.

2. The method of claim 1, further comprising displaying characters stored in the clip board on the dragged area upon the determination of whether the character exists indicates that no character exists on the dragged area.

3. The method of claim 2, wherein the displaying of the characters stored in the clip board comprises:
calculating a number of characters which are to be displayed on the dragged area; and
displaying characters stored in the clip board on the dragged area according to the number of characters.

4. The method of claim 1, further comprising:
determining whether a key input is detected;
determining whether the key input is a key input for selecting the clip board;
displaying characters stored in the clip board on the dragged area based on a result of the determining of whether the key input is the key input for the selecting of the clip board; and
displaying a character selected from among the displayed characters based on a determination of whether a key is input for selecting at least one character among the displayed characters.

5. The method of claim 4, further comprising displaying a character corresponding to the key being input upon the key input being a key input for inputting a character.

6. The method of claim 4, wherein the characters stored in the clip board comprise at least one of a character, digit, character string, digit string, and image.

7. A method of storing an image in a mobile terminal having a touch screen, comprising:
displaying the image;
recognizing an area dragged by a drag operation based on a determination of whether the drag operation on the displayed image is detected;
determining whether a touch is made on the dragged area;
recognizing the image corresponding to the dragged area based upon a determination of whether a touch on the dragged area is detected; and
storing the image in a clip board.

8. The method of claim 7, wherein the image comprises one of a character, digit, character string, digit string, photograph, and picture.

9. A mobile terminal comprising:
a touch screen;
a storage including a clip board to store a character existing on an area where a drag operation is detected; and
a controller, in a character writing mode, determining whether any character exists on an area dragged by a drag operation based on a determination of whether the drag operation is detected through the touch screen, determining whether a touch is made on the dragged area based on a determination of whether a character exists on the dragged area, and controlling the storage to store the character in the clip board based on a determination of whether a touch on the dragged area is detected.

10. The mobile terminal of claim 9, wherein, upon a determination that no character exists on the dragged area, the controller controls the touch screen to display characters stored in the clip board of the storage.

11. The mobile terminal of claim 10, wherein the character comprises at least one of a character, digit, character string, digit string, and image.
